(19) United States
(12) Patent Application Publication
(10) Pub. No.: US 2010/0000749 A1
(43) Pub. Date: Jan. 7, 2010

(54) Impact Wrench

(75) Inventor: Benjamin Andel, Fuerfeld (DE)

Correspondence Address: CENTRAL COAST PATENT AGENCY, INC, 3 HANGAR WAY SUITE D, WATSONVILLE, CA, 95076, US

(73) Assignee: Metabowerke GmbH, Nuertingen (DE)

(21) Appl. No.: 12/485,217

(22) Filed: Jun. 16, 2009

(30) Foreign Application Priority Data
Jul. 1, 2008 (EP) 08 011 817.7

(51) Int. Cl. B25B 21/02; B25D 11/04

(52) U.S. Cl. 173/48; 173/93.6; 173/202; 173/217

(57) ABSTRACT

The invention relates to an impact wrench having a drive motor for driving a drive shaft (10) and an output shaft (38) that can be coupled to a tool holder, and having an impact mechanism, the impact mechanism comprising an anvil (36) that has first impact cheeks (34) and that is coupled to the output shaft (38), and comprising a hammer, which is guided on the drive shaft (10), the hammer having second impact cheeks (24), which engage with the first impact cheeks (34) for the purpose of rotary transmission, wherein the hammer comprises a rotating mass (22) and a control part (20), the control part (20) carrying the second impact cheeks (24) and rotating with the drive shaft (10) in the case of non-impact and, in the case of impact, executing an axial and, preferably, additional, rotational oscillation relative to the drive shaft (10), the control part (20) transmitting the rotation of the drive shaft (10) to the rotating mass (22) and being movably guided in the axial direction in the rotating mass (22) for the purpose of realizing the impact function, and the rotating mass (22) not executing any axial movement.

The invention relates to an impact wrench, comprising a rotary impact mechanism for screwing and drilling, such impact wrenches being used, inter alia, to produce or undo high-tenacity screwed connections.

Impact wrenches have been known in the prior art for many years, the functioning of the rotary impact mechanism being based on the idea of temporarily storing the drive power of a motor and periodically delivering it to an output shaft within a very short working phase. These periodically delivered rotary pulses generate, in dependence on the pulse duration, a resultant driving torque that is significantly higher than would be possible in the case of a constant torque characteristic. From the drive side, the system obtains kinetic energy in the form of torque and rotational speed, this energy being temporarily stored in a component, for example in a spring or a rotating mass. The storage operation in each case continues until a control mechanism causes the stored energy to be delivered to an anvil, via a hammer. For this purpose, both the anvil and the hammer of the impact mechanism have impact cheeks, the hammer comprising a rotating mass, which is constituted by the solid part of the hammer, the kinetic energy being transferred to the anvil through acceleration of this mass. The anvil in this case is connected to the output, i.e. also to the threaded fitting, in a rotationally fixed manner. The control mechanism causes the energy to be delivered to the anvil in a time-limited manner, such that the connection is released again when the stored energy has been delivered.

In this case, there are two working phases in the impact mechanism, the energy being collected and stored in phase 1, and the stored energy being delivered back in phase 2. The energy stored in phase 1 is in this case determined by the input quantities of torque, rotational speed and number of impacts. The greater the number of impacts of the impact mechanism, the shorter is phase 1 time-wise and the less the energy that can be stored, since the motor can only apply a predefined torque and, consequently, the duration of the storage operation is decisive.

In the second phase, the duration of the energy delivery is likewise decisive. If the stored energy is delivered to the output in a relatively short time, the impact duration is thus shorter, and the torque peak produced is higher than in the case of a longer impact duration.

Basically, the typical torque characteristic of an impact wrench is produced in that energy is temporarily stored over a relatively long period of time, which energy is delivered abruptly to the output in a very short period of time.

In the case of impact, no torque is produced at the output between the torque peaks. Owing to this design, high tightening and loosening moments are possible with a compact design. Nevertheless, the reaction moment that has to be absorbed by the person working with the impact wrench is only the moment that is required to accelerate the rotating hammer mass in the impact mechanism, or to tension the spring. It is comparatively small, compared with the output torque.

Such an impact wrench has been previously described in, for example, DE 43 01 610 A1.

It can be desirable in this case for the rotating mass to be separated from the actual control part that acts together with the anvil, in order, for example, to maximize the volume of the rotating mass in the limited space of the electric hand-held power tool appliance or to render necessary a lesser axial structural space. There is known for this purpose, from DE 20 2007 011 843 U1, an impact mechanism for a power tool wherein the conventional hammer is replaced by a combined hammer, consisting of a hammer block and hammer seat. The hammer block in this case can drive the hammer seat, such that this hammer block rotates and moves in the axial direction in relation to the hammer seat. The hammer seat can then only move rotationally, but no longer axially. The hammer seat in this case comprises the actual rotating mass, the hammer block being guided in an axially movable manner in the hammer seat. There can thus be provided in the hammer seat, for example, recesses in which the impact cheeks of the hammer block are guided in an axially movable manner. In the prior art, provision is made whereby the impact cheeks of the hammer block protrude radially outwards from the hammer block and are received in the grooves. Moreover, it is intended that, upon release of tension of the spring that acts between the hammer seat and the hammer block, the impact cheeks of the hammer block project beyond the hammer seat in the axial direction and act together with the impact cheeks of the anvil.

Disadvantageous in the case of this design is the risk of the impact cheeks of the anvil, or of the hammer block, becoming skewed in relation to the hammer seat and to the drive shaft.

It is therefore the object of the invention to provide an impact wrench that does not have the said disadvantages.

The object of the invention is achieved by an impact wrench having the features of claim 1, namely, an impact wrench having a drive motor for driving a drive shaft and an output shaft that can be coupled to a tool holder, and having an impact mechanism, the impact mechanism comprising an anvil that has first impact cheeks and that is coupled to the output shaft, and comprising a hammer, which is guided on the drive shaft, the hammer having second impact cheeks, which engage with the first impact cheeks for the purpose of rotary transmission, wherein the hammer comprises a rotating mass and a control part, the control part carrying the second impact cheeks and rotating with the drive shaft in the case of non-impact and, in the case of impact, executing an axial and also, in particular, rotational oscillation relative to the drive shaft, and the control part transmitting the rotation of the drive shaft to the rotating mass, which does not execute any axial movement. The control part in this case is movably guided in the axial direction in the rotating mass for the purpose of realizing the impact function, the control part and the rotating mass being connected to one another in a rotationally fixed manner. In this case, the guidance of the control part in the rotating mass is so effected that the impact cheeks of the control part do not project beyond the rotating mass in the axial direction at any instant of operation, i.e., neither during rotating nor impacting operation. As a result of this design, the impact surfaces with which the impact cheeks of the control part impinge upon the impact cheeks of the anvil are arranged closer to the center of gravity of the rotating mass and, moreover, owing to the fact that the control part and, at least in part, the impact cheeks of the anvil are received in the rotating mass, the risk of skewing of the control part and of the anvil in relation to the rotating mass is reduced, and, consequently, the risk of the impact cheeks not meeting each other in an optimum manner and, consequently, of the impact energy not being able to be transmitted in an optimum manner, is also reduced. Moreover, a design wherein the control part and rotating mass are separated from one another offers the advantage that only a small mass is moved in the axial direction, and the vibrations in this direction are thereby reduced. Owing to the arrangement, moreover, the following advantages are achieved, namely, high contact ratio of the hammer, or control part, and the anvil, and consequently a good superposition of the impact pulse, a small tilting moment of the hammer, or control part, and better guidance of the control part in the rotating mass.

An impact wrench in this case operates as follows: Provision can thus be made, in a first case of non-impact, whereby the control part rotates with the anvil and the drive shaft, the impact cheeks of the anvil and of the control part bearing against each other and being in engagement, i.e., being in contact in the axial direction, this operation being effected until the maximum torque of the wrench is achieved without impacting. That is to say, it is normally effected until a first blocking of the screwed connection occurs. For the purpose of further tightening the screwed connection, a transition to impact operation is then effected automatically, an impact mechanism having been switched on, it being the case in impact operation that the anvil and the control part no longer bear against one another continuously, as in the case of screwing, by means of their impact cheeks that are arranged on mutually facing end faces of the control part and the anvil, but are separated from one another during the storage of energy, in order then to strike on one another in the circumferential direction upon the discharge of energy, and consequently the impact, and thus to deliver a momentarily greater torque.

In this case, in the case of impact, the control part normally executes a relative rotational movement in relation to the drive shaft, in addition to the relative axial movement in relation to the drive shaft. The axial and the rotational movements are oscillating.

Particularly preferably, provision can be made whereby the rotating mass has substantially the form of a hollow cylinder, and the axial ends can likewise have an extent in the radial direction that can be greater than the thickness of the shell, i.e., the end faces can extend towards the interior of the shell, forming a corner.

Provision is made in this case whereby, in each operating case, both during the storage of energy and upon discharge of energy for the impact, the control part does not act beyond the rotating mass in the axial direction.

Furthermore, provision can be made whereby, in the radial direction also, the control part either closes with the circumference of the rotating mass, i.e., in particular, is guided in grooves in the rotating mass that breach the outer circumference of the rotating mass, such that the outer contour, e.g. of the impact cheeks or of separate ribs of the control part, complements and, in particular, progressively continues the outer contour of the rotating mass, or, alternatively, provision can be made whereby the control part is so realized that, in the radial direction also, it is fully guided in the rotating mass and received in the latter. The grooves of the rotating mass then do not extend to the outer contour of the same. In this case, it is also possible for ribs to be provided, instead of the grooves, on the rotating mass, which ribs engage in grooves of the control part. In particular, in the case of this form, a particularly good guidance in the axial direction can be achieved upon the release of the stored energy to the control part, and tilting of the control part out of position can thus be prevented in a yet more reliable manner.

Particularly preferably, provision can be made in this case whereby the impact mechanism is realized as a V-groove impact mechanism, the control part executing, in the case of impact, an axially oscillating rotational movement in respect of the drive shaft. An axially oscillating rotational movement in this case is to be understood to mean that, in the case of impact, the control part executes both an axial and a rotational relative movement. The control part moves axially back and forth in a groove on the drive shaft, alternately in the direction of the drive-side end of the drive shaft and the output-side end of the drive shaft. The groove in this case is realized in a V shape, and the tip of the V points in the direction of the output side of the shaft, a relative rotational movement of the control part in relation to the drive shaft also being caused at the same time by the axial movement, owing to the V shape of the grooves. The control part in this case can be guided via a ball guide mechanism in the V-grooves, preferably two V-grooves being arranged diametrically opposite one another on the drive shaft. For this purpose, corresponding running surfaces for the ball can be provided in the control part.

A V-groove impact mechanism in this case operates as follows: Prior to occurrence of a case of impact, the anvil, via its impact cheeks, which bear against the impact cheeks of the control part, rotates together with the control part and the drive shaft without any relative movement being effected between the individual components. The control part in this case also drives the rotating mass. Upon the presence of a relatively large torque, there then occurs a decoupling of the impact cheeks between the anvil and the control part, owing to the fact that this greater torque cannot be applied through the normal tightening torque of the impact wrench. Owing to the further drive-shaft rotation that is transmitted to the control part, and owing to the counter-holding of the anvil, the control part moves in the V-grooves on the drive shaft. Owing to the provision of the V-grooves, the control part is moved away from the anvil in the axial direction, at the same time as the rotation relative to the drive shaft, and the impact cheeks of the control part and of the anvil become superposed in a locking manner in the axial direction. Owing to the release of the control part from the anvil, the control part can again move freely in the rotational direction, and is accelerated by the stored energy that is stored in a spring through the axial movement of the control part in the drive direction, until, at the end of its rotary movement and axial movement, it impinges, by means of its impact cheeks, against the impact cheeks of the anvil and thus executes, in the circumferential direction, an impact that results in a further tightening or loosening of the screwed connection that is being worked.

After the impact, the impact mechanism is re-tensioned through axial and radial movement of the control part.

Provision can be made in this case whereby grooves or ribs are provided in the preferably hollow-cylindrical rotating mass, which grooves or ribs can extend to the outer circumference of the rotating mass, or are provided only in the interior of the rotating mass, without extending to the circumferential or outer surface of the rotating mass.

The control part is then guided in the axial direction in or on these grooves or ribs via appropriate, corresponding ribs or grooves, which can be constituted, for example, by separate ribs or grooves, but also by the impact cheeks of the control part, and, at the same time, the rotary transmission from the control part to the rotating mass is effected via this coupling.

Moreover, arranged between the rotating mass and the control part there is a spring, which serves to store and release the impact energy, the spring bearing against the rotating mass and the control part.

Provision can be made in this case whereby an axial bearing, particularly in the form of a ball bearing, can be provided in the axial direction between the rotating mass and the drive shaft, in order to allow the relative movement, in respect of rotation, between the rotating mass and the drive shaft, and to support the rotating mass on the drive shaft.

Insofar as the control part is received fully in the rotating mass, i.e., both in the axial and in the radial direction, it is particularly advantageous if the impact cheeks of the control part and of the anvil, which likewise go fully or partially into the rotating mass in order to act together with the impact cheeks of the control part, have only a small amount of play in relation to the wall of the rotating mass in the radial direction. The same applies to the impact cheeks of the control part. In this way, the structural space can be utilized in a particularly efficient manner, and the impact cheeks can be realized to be as large as possible and, at the same time, guidance of the impact cheeks against skewing can be achieved.

The division of the hammer into a separate control part and a separate rotating mass therefore offers the advantage, in addition to the possibility of providing a greater rotating mass with, at the same time, a lesser axial structural-space requirement for the movement for generating the impact, that less vibration is produced in the axial direction, since the rotating mass does not execute any axial movement, and only the control part, which has a substantially lesser mass, is moved in the axial direction. Since the mass of the control part is significantly less than that of the rotating mass, the vibration excitation in the direction of the axis of rotation is reduced considerably. Moreover, owing to the impact cheeks of the control part being arranged within the rotating mass, i.e., without these impact cheeks projecting beyond the rotating mass in the axial direction, the impact cheeks can be arranged closer to the center of gravity of the rotating mass, and, moreover, skewing can be more reliably prevented by the guidance in the rotating mass, particularly insofar as the rotating mass also receives the control part in the radial direction.

According to a further preferred design, provision can be made whereby the impact wrench is a battery-powered impact wrench, battery-powered appliances normally having the advantage of being easier to use at any location, and also in difficult applications. Moreover, the impact function is advantageous in the case of battery-powered appliances particularly because, in the case of appliances having a direct electrical connection, the torque rating can be so effected that higher torques are achieved, such that, if appropriate, it is possible to work without an additional impact function.

Further advantages and features of the invention are disclosed by the other application documents. The invention is explained more fully in the following with reference to a drawing, wherein:

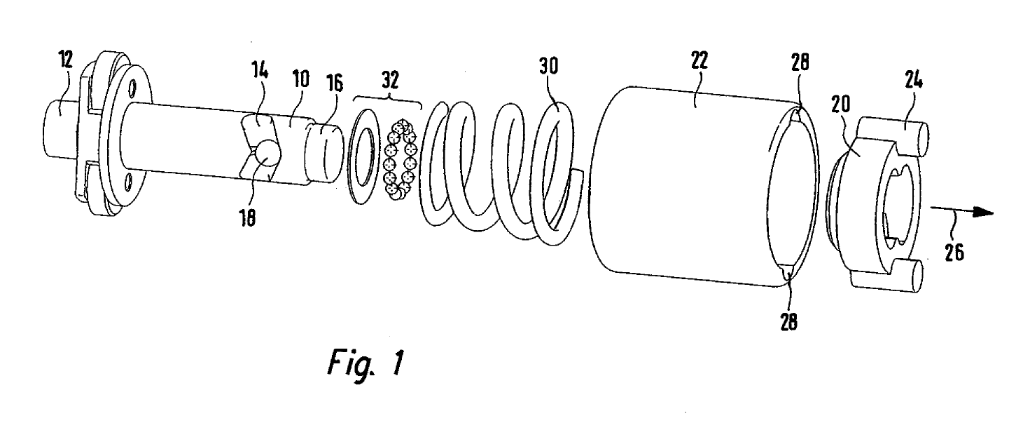

FIG. 1 shows an exploded representation of an impact mechanism of an impact wrench

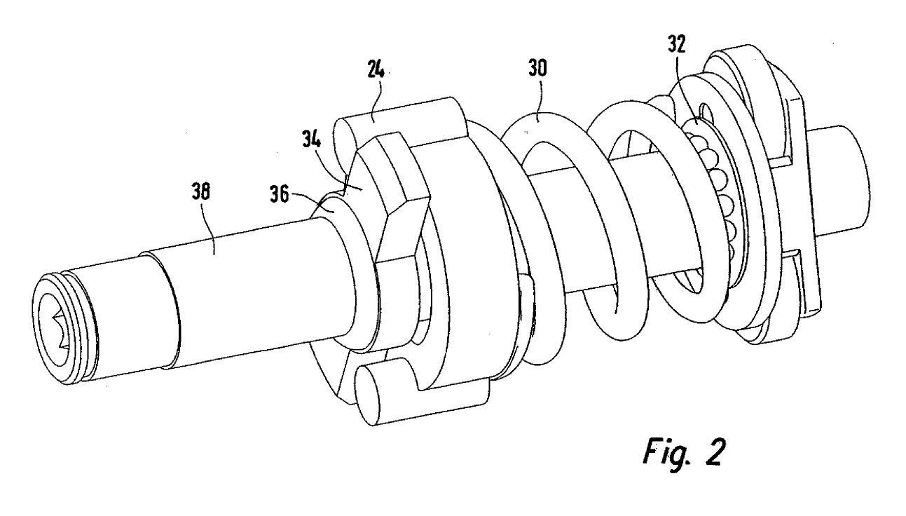

FIG. 2 shows an assembled representation of a design of the impact mechanism without a rotating mass

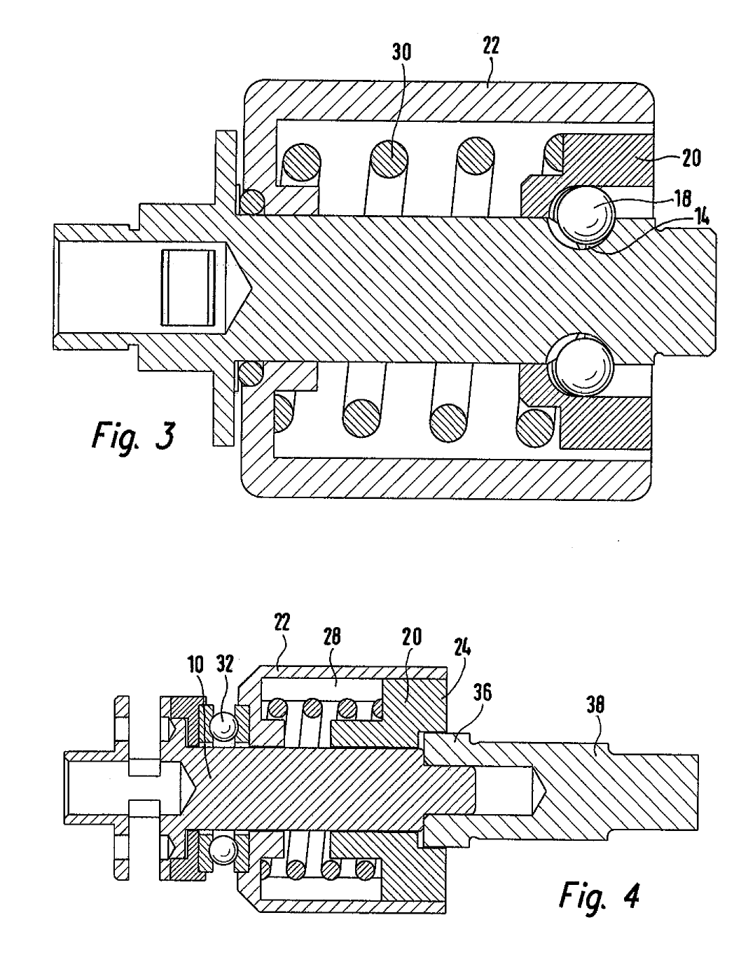

FIG. 3 shows an impact mechanism, in an assembled form, without an anvil, and

FIG. 4 shows a longitudinal section through an impact mechanism in an assembled form

FIG. 1 shows an impact mechanism according to the invention, having a drive shaft 10 that comprises, on the drive side, an end 12, by means of which said drive shaft can be coupled to a drive motor (not represented), in particular via a transmission. V-shaped grooves 14 are provided in the drive shaft 10, the tip of the V-shaped grooves pointing towards the output-side end 16 of the drive shaft 10. Guided in each case in the V-shaped grooves 14, two grooves 14 being arranged diametrically opposite one another in the drive shaft 10, is a ball 18, corresponding running surfaces (not shown), for receiving the ball 18, being provided in a control part 20. Owing to the grooves 14 and the ball guides 18, the control part 20 can move, relative to the drive shaft 10, in the region of the grooves 14 and, in particular, execute both an axial and a rotational, oscillating motion. Moreover, the impact mechanism comprises a rotating mass 22, the rotating mass 22, together with the control part 20, constituting the so-termed hammer of the impact mechanism.

The control part 20 moreover comprises impact cheeks 24, which project, in the axial direction 26, beyond the actual control part in the output-side direction, and which act together with impact cheeks of an anvil, which are not shown in FIG. 1. The control part 20 is in this case movably guided in the rotating mass 22 in the axial direction, but coupled to the rotating mass 22 in a rotationally fixed manner. For this purpose, the rotating mass 22 comprises grooves 28, in which the impact cheeks 24 engage, and in which the latter are movable in the axial direction and via which the rotary transmission is effected.

The grooves 28 in this case are arranged fully within the rotating mass 22, such that the control part 20 does not project beyond the rotating mass 22 in the radial direction in any operating state, but is received fully in this rotating mass.

For the purpose of storing energy and generating the impact energy, there is moreover provided a spring 30, which is arranged between the control part 20 and the drive shaft 10, and which becomes compressed to form an energy storage as the control part 20 moves along the V-grooves 14, the energy then being discharged again upon the impact cheeks 24 becoming separated from the impact cheeks of the anvil. There is moreover provided an axial bearing 32, which is arranged between the drive shaft 10 and the rotating mass 22.

Owing to this structure, the rotating mass 22 does not execute any axial movement, and therefore also does not cause any vibration in this direction, and the rotating mass 22 can follow the relative rotation, in relation to the drive shaft 10, executed by the control part 20.

FIG. 2 now shows a design of the impact mechanism in assembled form, the axial bearing 32 being arranged between the drive shaft 10 and the rotating mass 22, the rotating mass 22 not being represented here. Shown here is the engagement of the impact cheeks 24 with the impact cheeks 34 of the anvil 36, which is coupled to an output shaft 38 that is connected to a tool holder.

In this case, the impact cheeks 34 of the anvil 36 are so designed that they are received fully in the rotating mass 22 and surrounded by the rotating mass 22 in the radial direction.

In the case of screwing, rotation is now transmitted by the control part 20, which is driven by the drive shaft 10, both to the rotating mass 22 and, via the impact cheeks 24 and 34, to the anvil 36, and thereby to the tool. If there is then a first blocking of the tool, and thereby a blocking of the anvil 36, the further drive of the drive shaft 10 causes relative rotational and axial movement of the control part 20 in the V-grooves in the direction of the drive-side end 12 of the drive shaft 10, and there is thus separation of the impact cheeks 24 from the impact cheeks 34, with simultaneous compression of the spring 30, and the energy is stored in the spring 30. Following the separation of the impact cheeks 24 from the impact cheeks 34, there is then release of the tension of the spring 30 and a further movement in the V-grooves 14, the stored energy of the spring 30 then being discharged through an impact of the impact cheeks 24 against the impact cheeks 34. Moreover, in the rotational movement, the rotating mass 22 is driven concomitantly, but it does not execute any axial movement, such that the impact energy can be provided by the, compared with the control part 20, greater rotating mass 22.

FIG. 3 now shows a design, again without an anvil, but with a rotating mass 22 in place, wherein it can be seen that the control part 20 is fully surrounded by the rotating mass 22 in both the axial and the radial direction, the rotating mass 22 here having a running or guide surface for the balls 18 that are guided in the V-grooves 14. Not represented in the present sectional plane is the axial guidance, via the impact cheeks 24, in the grooves of the rotating mass 22.

FIG. 4, finally, shows a fully assembled impact mechanism, comprising an output shaft 38 with the anvil 36, the impact cheeks 34 not being visible in the present section, there being shown instead, in section, the impact cheeks 24 of the control part 20, which impact cheeks are guided in grooves 28 of the rotating mass 22 and, for the purpose of transmitting rotational energy, act together with the impact cheeks 34 of the anvil 36, which, likewise, go into the rotating mass 22.

The axial bearing 32 is provided between the rotating mass 22 and the drive shaft 10, in order to ensure a purely rotational relative movement of the rotating mass 22. Owing to the arrangement of the impact cheeks 24 in the rotating mass 22 and, consequently, the engagement of the impact cheeks 34 in the rotating mass 22, the impact cheeks 24 have their full length located within the grooves 28 of the rotating mass 22. The surface area via which the pulse is transmitted from the rotating mass 22 to the control part 20 is thereby increased. In addition, the transmission surfaces are thereby located closer to the center of inertia of the rotating mass 22.

Particularly preferably, the transmission surfaces are so realized between the impact cheeks of the control part 20 and of the anvil 36 that they bear flatly against one another. Alternatively, as shown in FIGS. 1 and 2, they can also be so realized that only a linear contact occurs.

Insofar as it is necessary for the impact cheeks 34 of the anvil 36 to be shortened in respect of their length in the radial direction in comparison with the prior art, since they now come to be located within the rotating mass 22, they can be widened accordingly, in order to provide the necessary stiffness.

Further features and advantages are disclosed by the other documents.

1. Impact wrench having a drive motor for driving a drive shaft and an output shaft that can be coupled to a tool holder, and having an impact mechanism, the impact mechanism comprising an anvil that has first impact cheeks and that is coupled to the output shaft, and comprising a hammer, which is guided on the drive shaft, the hammer having second impact cheeks, which engage with the first impact cheeks for the purpose of rotary transmission, wherein the hammer comprises a rotating mass and a control part, the control part carrying the second impact cheeks and rotating with the drive shaft in the case of non-impact and, in the case of impact, executing an axial and, preferably, an additional, rotational oscillation relative to the drive shaft, the control part transmitting the rotation of the drive shaft to the rotating mass and being movably guided in the axial direction in the rotating mass for the purpose of realizing the impact function, and the rotating mass not executing any axial movement, characterized in that the impact cheeks of the control part do not project beyond the rotating mass in the axial direction.

2. Impact wrench according to claim 1, characterized in that the impact cheeks of the anvil go fully or partially into the rotating mass in the axial direction.

3. Impact wrench according to claim 1, characterized in that the rotating mass is connected to the control part in a rotationally fixed manner.

4. Impact wrench according to claim 1, characterized in that the rotating mass has the form of a hollow cylinder.

5. Impact wrench according to claim 1, characterized in that a spring is guided in the rotating mass for the purpose of storing and releasing the impact energy, and the spring bears against the rotating mass and the control part.

6. Impact wrench according to claim 1, characterized in that the impact mechanism is realized as a V-groove impact mechanism, there being realized in the drive shaft and in the control part V-grooves by means of which the control part (20) is moved on the drive shaft via balls, which are guided in the grooves.

7. Impact wrench according to claim 1, characterized in that the rotating mass has grooves, in which there engage ribs constituted, in particular, by the impact cheeks of the control part.

8. Impact wrench according to claim 7, characterized in that the ribs of the control part, by means of their circumferential surface, complement the circumferential surface of the rotating mass.

9. Impact wrench according to claim 1, characterized in that the control part is received in the rotating mass in the radial direction and is surrounded by this rotating mass.

10. Impact wrench according to claim 1, characterized in that an axial bearing is provided between the rotating mass and the drive shaft.

11. Impact wrench according to claim 1, characterized in that the impact cheeks of the anvil and/or of the control part have only a small amount of play in relation to the wall of the rotating mass in the radial direction.

12. Impact wrench according to claim 1, characterized in that the impact wrench is a battery-powered appliance.
